(19) United States
(12) Patent Application Publication
(10) Pub. No.: US 2026/0045034 A1
(43) Pub. Date: Feb. 12, 2026

(54) IMAGE PROCESSING SYSTEM, CONTROL METHOD, AND STORAGE MEDIUM

(71) Applicant: CANON KABUSHIKI KAISHA, Tokyo (JP)

(72) Inventor: Hidenori ITO, Tokyo (JP)

(21) Appl. No.: 19/277,588

(22) Filed: Jul. 23, 2025

(30) Foreign Application Priority Data
Aug. 8, 2024 (JP) 2024-133274

(51) Int. Cl. G06T 17/00; G06T 19/00

(52) U.S. Cl. CPC G06T 17/00; G06T 19/00

(57) ABSTRACT

An image processing system acquires an image based on image capturing by an image capturing device and depth information indicating a predetermined distance range from the image capturing device and displays, in different display manners, a first object present in the predetermined distance range and a second object not present in the predetermined distance range among objects in the image.

### BACKGROUND

### Field of the Technology

The present disclosure relates to an image processing system, a control method, and a storage medium.

### Description of the Related Art

Methods of generating a three-dimensional model of an object from captured images acquired by a plurality of image capturing devices include a known method of generating a three-dimensional model by a shape from silhouette method using a silhouette image obtained by separating a part corresponding to the object from a captured image including an object of interest.

In order to accurately generate a three-dimensional model for the shape of the object, it is necessary to accurately separate object regions included in each captured image. Japanese Patent Laid-Open No. 2018-129736 discloses a method of confirming an object region separation result of each image capturing device. In this technique, an image of an object (object region) that is a generation target of a three-dimensional model is acquired from each captured image, and these images are displayed on a monitoring screen as an image representing an image capturing state of the object.

Depending on the installation position of the image capturing device with respect to a three-dimensional model generation target space, there is a case where a part of the generation target space of the three-dimensional model is out of an in-focus range of the image capturing device. For example, when a wide space such as a soccer stadium is a target space for generating a three-dimensional model, in a case where the image capturing device cannot be installed at a sufficiently high position with respect to the target space, the depression angle of the image capturing device is small, and a part of the target space included in the captured image is out of the in-focus range. If the object is present in a region outside the in-focus range with a certain image capturing device, the object can be blurred and captured, and there is a possibility that the object cannot be accurately separated. On the other hand, Japanese Patent Laid-Open No. 2022-110751 discloses generating a three-dimensional model by using a captured image of an image capturing device that is determined to include an object that is a generation target of the three-dimensional model in an in-focus range.

Use of the technique of Japanese Patent Laid-Open No. 2018-129736 enables a result of separating an object from each captured image to be confirmed on a display device.

### SUMMARY

However, in a case where a three-dimensional model is generated using only an image of an object included in an in-focus range as in Japanese Patent Laid-Open No. 2022-110751, there is a problem of failing to confirm as to which part in an object included in a captured image to be an object included in a predetermined range such as an in-focus range.

The present disclosure has been made in view of the above problem, and provides a technique for confirming as to which object of the objects included in captured images acquired by a plurality of image capturing devices to be included in a predetermined range.

According to one aspect of the present disclosure, there is provided an image processing system acquiring an image based on image capturing by an image capturing device and depth information indicating a predetermined distance range from the image capturing device and displaying, in different display manners, a first object present in the predetermined distance range and a second object not present in the predetermined distance range among objects in the image.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are views illustrating configuration examples of an image processing system according to one embodiment.

FIG. 2 is a view illustrating a functional configuration example of the image processing system according to one embodiment.

FIG. 3 is an explanatory view of an effective depth range according to one embodiment.

FIG. 4 is a view illustrating a hardware configuration example of the image processing system according to one embodiment.

FIG. 5 is a flowchart showing an operation of the image processing system according to one embodiment.

FIG. 6 is a flowchart showing an operation of a partial region specification unit according to one embodiment.

FIG. 7A is a view illustrating an example of a captured image of a camera 102A according to one embodiment.

FIG. 7B is a view illustrating an example of a silhouette image according to one embodiment.

FIG. 8A is a view illustrating an example of an effective depth range of the camera 102A according to one embodiment.

FIG. 8B is a view illustrating an example of a generation result of a three-dimensional model according to one embodiment.

FIG. 8C is a view illustrating an example of a partial region image according to one embodiment.

FIG. 9 is a view illustrating an example of captured images of all cameras according to one embodiment.

FIG. 10 is a view illustrating an example of silhouette images of all cameras according to one embodiment.

FIG. 11 is a view illustrating images of partial regions (regions used for three-dimensional model generation) of all cameras according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

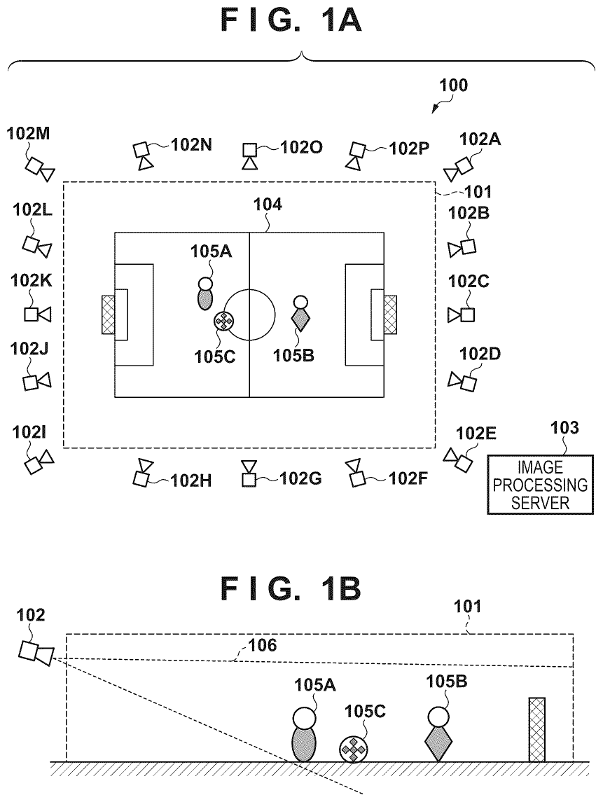

For example, the camera 102A and a camera 102B illustrated in FIG. 1A indicate different instances having an identical function. Note that having an identical function means having at least a specific function (such as an image capturing function), and for example, a part of the functions and performances of the camera 102A and the camera 102B may be different.

### FIRST EMBODIMENT

In the present embodiment, an example of overlapping, on a silhouette image of an object included in captured images, a partial region that is an object region used for generation of a three-dimensional model in the captured images by a plurality of cameras installed so as to capture a target space for generating the three-dimensional model will be described. In generation of the three-dimensional model, a range (effective depth range) in a depth direction used for the generation of the three-dimensional model in a range captured by each camera is set for each camera, and an object region used for the generation of the three-dimensional model is specified as a partial region.

### System Configuration

FIG. 1A is a view illustrating a configuration example of an image processing system according to the present embodiment. FIG. 1B is a cross-sectional view illustrating a positional relationship between an arbitrary camera 102 and a three-dimensional model generation target space 101. Note that in the present embodiment, a soccer stadium is the image capturing target, but the present disclosure is not limited to this example. The present embodiment can also be applied to other types of stadiums such as baseball, basketball, and volleyball, or concert halls, and the like.

In the three-dimensional model generation target space 101, a playing field 104 and an object 105 to be a generation target of the three-dimensional model are present. In a case of soccer, the object 105 includes an object 105A and an object 105B that are players and an object 105C that is a soccer ball.

The camera 102 including cameras 102A to 102P are arranged around the three-dimensional model generation target space 101. Each of the cameras 102 captures a part of the three-dimensional model generation target space 101. In FIG. 1A, the cameras 102 are arranged so as to surround the periphery of the playing field 104 on a plan view of the three-dimensional model generation target space 101 viewed from above. The camera 102 is installed at a position having a certain height. An image capturing range 106 indicates a range captured by the camera 102. In this example, as illustrated in FIG. 1B, the object 105A, the object 105B, and the object 105C are included in the image capturing range 106 of the camera 102, and these objects are included in the captured image.

An image processing server 103 is an image processing device that receives a captured image of each of the cameras 102 and performs generation processing of the three-dimensional model of an object. The image processing server 103 overlaps, on a silhouette image of the object included in a captured image, a partial region that is an object region used for generation of the three-dimensional model in the captured image. This enables each of the cameras 102 to monitor an image capturing situation of the object, and enable adjustment of the partial region of the object used for generation of the three-dimensional model.

### Functional Configuration

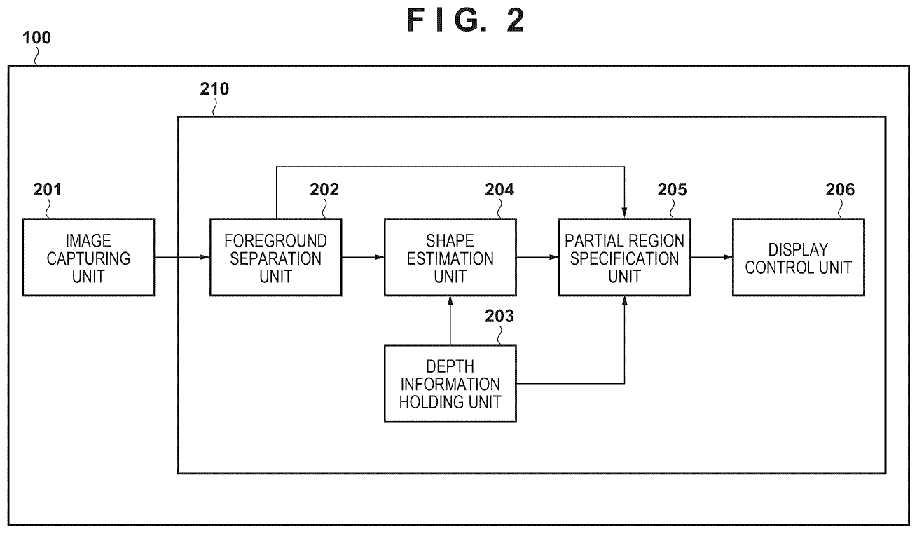

FIG. 2 is a view illustrating a functional configuration example of an image processing system 100 according to the present embodiment. The image processing system 100 includes an image capturing unit 201 and an image processing unit 210. The image capturing unit 201 captures an object of a generation target of the three-dimensional model. Then, the image processing unit 210 generates the three-dimensional model of the object, and specifies and displays an object region (partial region) indicating a part used for generation of the three-dimensional model in the object included in each captured image captured by the image capturing unit 201.

The image capturing unit 201 is an image capturing device group arranged and installed so as to capture the three-dimensional model generation target space 101 from all directions. Each image capturing device corresponds to the camera 102 in FIGS. 1A and 1B, and captures a part of the three-dimensional model generation target space 101. The image capturing unit 201 transmits a captured image acquired by each of the cameras 102 to the image processing unit 210.

The image processing unit 210 includes a foreground separation unit 202, a depth information holding unit 203, a shape estimation unit 204, a partial region specification unit 205, and a display control unit 206. Each process of the image processing unit 210 is executed by the image processing server 103 illustrated in FIG. 1.

The foreground separation unit 202 performs processing of separating and excluding an object region from each captured image. The foreground separation unit 202 outputs a silhouette image of the object obtained as a result of separation to the shape estimation unit 204 and the partial region specification unit 205. For example, a background difference method or a machine learning method can be applied to the foreground separation processing.

The background difference method is a method of generating a silhouette image of an object by calculating a difference between a background image corresponding to an image in a state where the object is not present in the captured image and a captured image in a state where the object is present. Acquisition methods of a background image include a method in which a captured image at the moment when the object is not present is used as a background image. It is also possible to apply a method of acquiring a captured image in a certain period, observing a change in pixel value in units of pixels and small regions, and adopting, as a pixel value constituting the background image, a mean value or a latest pixel value within the certain period in a case where the change in pixel value falls within a certain amount or less.

The machine learning method is a method performed using a model learned in advance so as to cut out only an object part in a captured image. This learning model can be implemented by a model by a convolutional neural network (CNN) that executes a semantic segmentation task for performing class identification for each pixel of an input image, for example.

Note that the generation method of the silhouette image of the object used by the foreground separation unit 202 is not limited to the background difference method or the machine learning method.

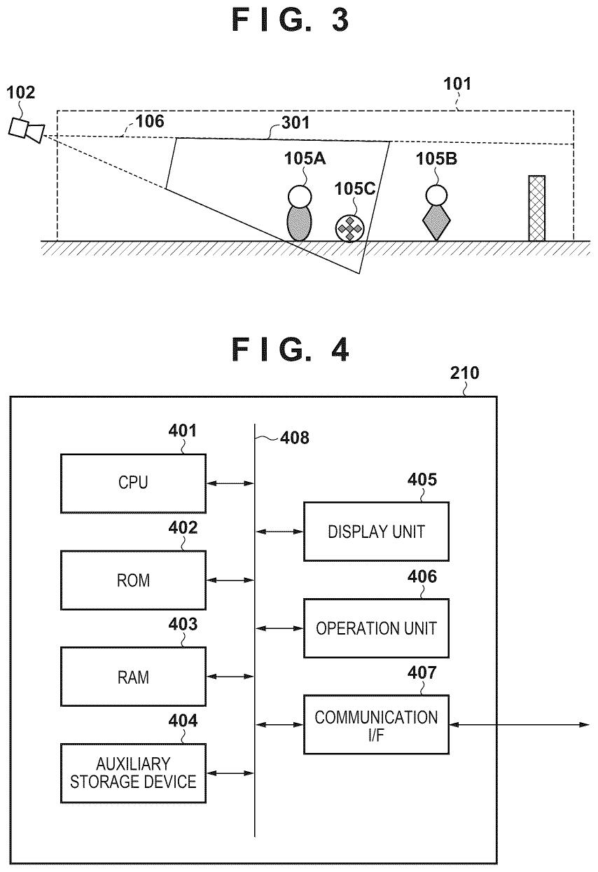

The depth information holding unit 203 holds information indicating which part of the image capturing range of each of the cameras 102 is to be used for generation of the three-dimensional model. The depth information is depth information indicating a predetermined distance range from the image capturing unit 201, and is information indicating a use range for three-dimensional model generation in a depth direction in an image capturing range of a certain camera 102 as an effective depth range 301 illustrated in FIG. 3, for example. The camera 102 in FIG. 3 captures a region included in the image capturing range 106 in the three-dimensional model generation target space 101, and the region used for generation of the three-dimensional model is only the region indicated by the effective depth range 301. As the effective depth range, a range where the object region included in the captured image can be accurately separated is determined.

One of the determination methods of the effective depth range is a method of determining an in-focus range determined from sensor information of the camera or the setting of a lens (focal length, object distance, and aperture) as an effective depth range. This decision method is based on the idea that the object region can be accurately separated as long as the object is in a range where the object is captured in a focused state.

However, the effective depth range does not necessarily need to be set to match an in-focus range, and the user may decide the effective depth range to be a range where the object region can be accurately separated. For example, in a case where the size in which the object is captured becomes small even within the in-focus range, there is a case where the separation cannot be accurately performed depending on the separation method of the object region. In this case, the effective depth range may be set such that the rear side of the in-focus range is outside an effective region.

The range where the object region can be accurately separated needs to be adjusted by confirming a silhouette image of the object obtained by separating actually. For example, a pixel value (luminance or hue) on a captured image of an object of a three-dimensional model target, a playing field, and the like changes depending on weather or a situation of the field. By this, a relative pixel difference value between the object part to be separated and the other parts changes, and there is a case where accuracy cannot be confirmed unless the object region is separated using an actually captured image. Therefore, it is necessary to adjust the effective depth range by confirming the separation result. In this case, an object silhouette included in the partial region (region used for three-dimensional model generation) displayed by the display control unit 206 described later is confirmed and adjusted. That is, the depth information may indicate the effective depth range adjusted by the user or may be set by the user. The depth information may be determined by setting of the image capturing unit 201, or may be information based on the focal length of the image capturing unit 201.

The depth information holding unit 203 outputs the effective depth range in the three-dimensional model generation target space 101 of each of the cameras 102 to the shape estimation unit 204 and the partial region specification unit 205.

The shape estimation unit 204 performs shape estimation processing of generating a three-dimensional model using the silhouette image of the object obtained by separating the object region from each captured image and the effective depth range of each of the cameras 102. As the shape estimation processing, for example, the shape from silhouette method can be used. In the shape from silhouette method, first, cuboids of a unit volume called voxels are laid in a generation target space of a three-dimensional model. The three-dimensional model is generated by repeating, for all the cameras 102, projecting, onto the captured image of the camera 102, a voxel of this voxel cloud included in the image capturing range and the effective depth range of each of the cameras 102, and excluding voxels of a part not included in the object silhouette.

In the present embodiment, the three-dimensional model is described as a point cloud that is an aggregate of voxels, but the three-dimensional model is not limited to the point cloud. The three-dimensional model may be, for example, a three-dimensional mesh in which a point cloud generated by the shape from silhouette method is converted. Alternatively, the three-dimensional model may be a three-dimensional mesh generated by another three-dimensional model generation method. The shape estimation unit 204 outputs the generated three-dimensional model to the partial region specification unit 205.

The partial region specification unit 205 specifies an object present in a predetermined distance range based on a three-dimensional model generated based on a captured image, the three-dimensional model being included in a range corresponding to a predetermined distance range from the image capturing unit 201 in a virtual space. The object present in the predetermined distance range is an object corresponding to the three-dimensional model generated based on the captured image, the three-dimensional model being included in the range corresponding to the predetermined distance range from the image capturing unit 201 in the virtual space. More specifically, the partial region specification unit 205 specifies a partial region used (contributed) to generation of the three-dimensional model in the silhouette image of the object included in each captured image. For specification of the partial region, a silhouette image obtained by separating and excluding the object region by the foreground separation unit 202, depth information (e.g., effective depth range) received from the depth information holding unit 203, and a three-dimensional model generated by the shape estimation unit 204 are used. A specification method of the partial region (region used for generation of the three-dimensional model) using them will be described later in the description of the operation using the flowchart. The partial region specification unit 205 outputs information on the specified partial region to the display control unit 206.

The display control unit 206 distinguishably displays an object present in a predetermined distance range from the image capturing unit 201 and an object not present in the predetermined distance range among objects in the captured image. More specifically, for each captured image, the display control unit 206 causes a display unit 405 to superimpose the partial region used for generation of the three-dimensional model on the silhouette image of the object included in the captured image. An example of a display method in the present embodiment will be described later in the description of the operation Using the flowchart.

### Hardware Configuration

Next, a hardware configuration of the image processing unit 210 in the image processing system 100 according to the present embodiment will be described with reference to FIG. 4. The image processing unit 210 includes a CPU 401, a ROM 402, a RAM 403, an auxiliary storage device 404, the display unit 405, an operation unit 406, a communication I/F 407, and a bus 408.

The CPU 401 controls the entire image processing unit 210 using a computer program and data stored in the ROM 402 and the RAM 403, and implements each function of the image processing unit 210. Note that the image processing unit 210 may have one or a plurality of pieces of dedicated hardware different from the CPU 401, and at least part of the processing by the CPU 401 may be executed by the dedicated hardware. Examples of the dedicated hardware include an application specific integrated circuit (ASIC), a field programmable gate array (FPGA), and a digital signal processor (DSP).

The ROM 402 stores a program and the like that do not need to be changed. The RAM 403 temporarily stores a program and data supplied from the auxiliary storage device 404, data supplied from the outside via the communication I/F 407, and the like. The auxiliary storage device 404 includes, for example, a hard disk drive, and stores various data. The RAM 403 and the auxiliary storage device 404 hold a captured image input from the image capturing unit 201, intermediate data in the middle of processing of the image processing unit 210, and output data for display.

The display unit 405 includes, for example, a liquid crystal display and a light-emitting diode (LED), and displays a graphical user interface (GUI) for the user to control the entire image processing system 100. In order to monitor the image capturing situation of the object by each camera, a partial region of the object used for generation of the three-dimensional model in captured images by the plurality of cameras is superimposed on the silhouette image of the object included in the captured images.

The operation unit 406 includes, for example, a keyboard, a mouse, a joystick, and a touch panel, and inputs various instructions to the CPU 401 in response to a user operation. The CPU 401 operates as a display control unit that controls the display unit 405 and an operation control unit that controls the operation unit 406.

The communication I/F 407 is used for communication with an external device. It is used for outputting a control instruction of the entire image processing system 100 including the image capturing unit 201, inputting a captured image from the image capturing unit 201, and the like. This I/F is implemented by a wired network I/F such as Ethernet, a wireless network I/F such as a wireless LAN, a serial digital interface (SDI) I/F that transmits and receives video signals, or the like. The bus 408 connects the units constituting the image processing unit 210 to transmit information.

The present embodiment assumes that the display unit 405 and the operation unit 406 are present inside the image processing unit 210, but at least one of the display unit 405 and the operation unit 406 may be present as another device outside the image processing unit 210.

### Processing

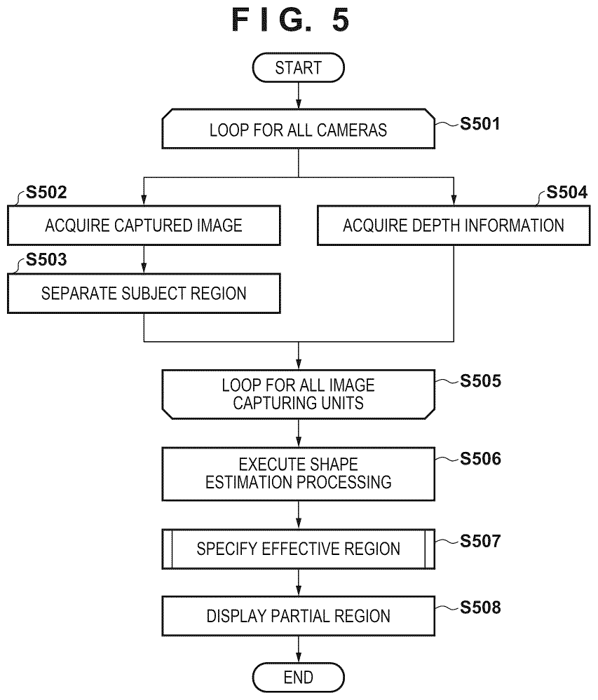

Next, the operation of the image processing system according to the present embodiment will be described with reference to FIGS. 5 to 11. FIG. 5 is a flowchart showing the operation of the image processing system 100 according to the present embodiment.

In S501, the image processing system 100 starts a loop of processing for all the cameras. The example illustrated in FIG. 1 assumes a loop from the camera 102A to the camera 102P.

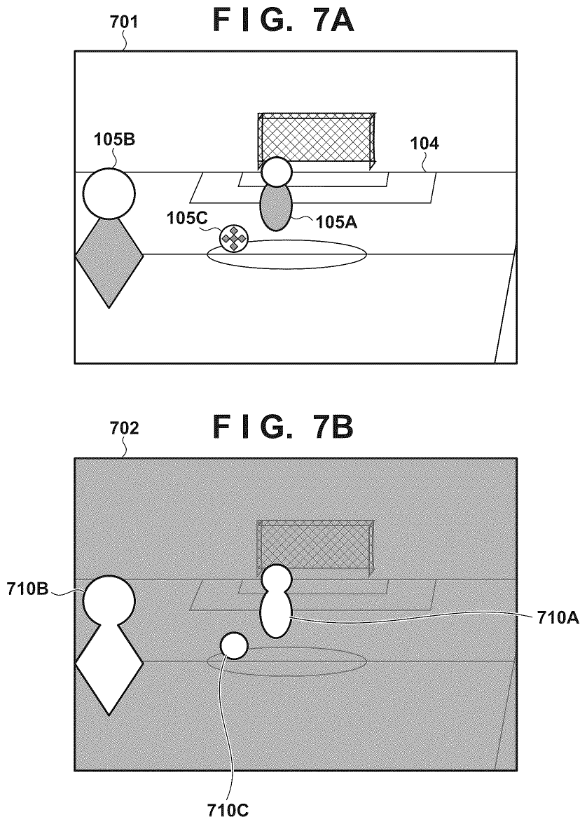

In S502, the image capturing unit 201 acquires a captured image. Upon acquiring the captured image, each of the cameras 102, which is the image capturing unit 201, transmits the captured image to the image processing unit 210. Here, an example of the captured image is illustrated in a captured image 701 in FIG. 7A. The captured image 701 indicates a captured image obtained by the camera 102A capturing the three-dimensional model generation target space 101 in the image processing system 100 of the present embodiment. The captured image 701 includes the playing field 104 present in the three-dimensional model generation target space 101 and the objects 105A to 105C. The camera 102A included in the image capturing unit 201 outputs the captured image 701 to the foreground separation unit 202.

In S503, the foreground separation unit 202 performs separation processing of the object region included in the captured image. The separation processing is performed using the background difference method or the machine learning method described above. An example of a result of separation processing of the object region is illustrated in a silhouette image 702 in FIG. 7B. In the silhouette image 702, a part where the object is present and separated as an object region is filled as a white region, and the other part is filled as a gray region. The silhouette image 702 includes object silhouettes 710A to 710C corresponding to the objects 105A to 105C included in the captured image 701. The foreground separation unit 202 outputs the silhouette image 702, which is the result of the separation processing of the object region, to the shape estimation unit 204 and the partial region specification unit 205.

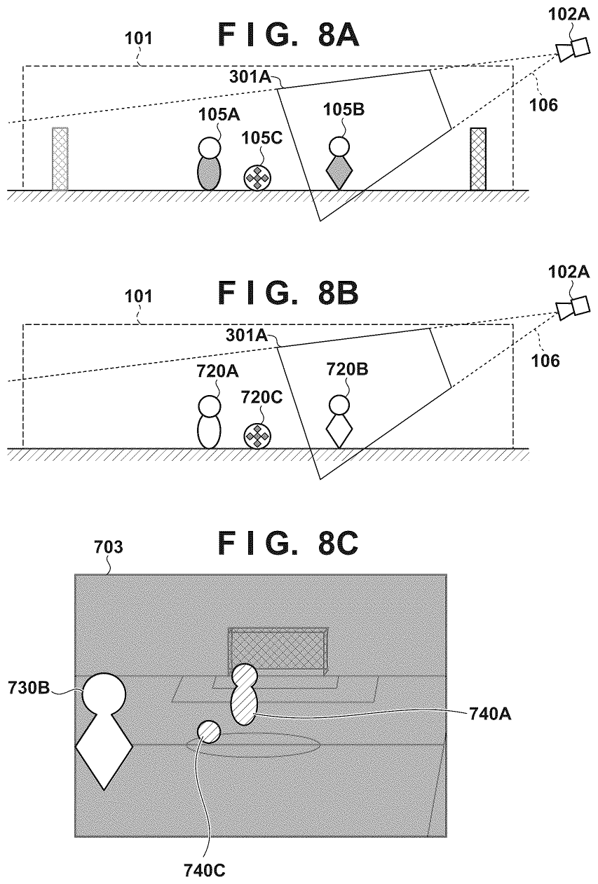

In S504, the depth information holding unit 203 acquires depth information. The depth information is information set for each of the cameras 102. As illustrated in the effective depth range 301 in FIG. 3, a region used for shape estimation processing for generating the three-dimensional model is set in the depth direction of the image capturing range of the camera 102. Here, an example of the effective depth range of the camera 102A is illustrated in an effective depth range 301A in FIG. 8A. The user of the image processing system 100 sets such the effective depth range 301 in advance for all the cameras 102. The depth information holding unit 203 outputs the effective depth range 301 of each of the cameras 102 to the shape estimation unit 204 and the partial region specification unit 205.

In S505, in a case where the loop of all the cameras has ended, the image processing system 100 proceeds to S506. In a case where there is still a remaining camera, the process returns to S501 to repeat the processing. In the example illustrated in FIG. 1, when the processing of S502 to S504 is completed for each of the camera 102A to the camera 102P, this loop ends.

In S506, the shape estimation unit 204 performs shape estimation processing of the object and generates the three-dimensional model of the object. The generation processing of the three-dimensional model by the shape estimation unit 204 is performed using the silhouette images 702 of all the cameras 102 and the effective depth range 301. For example, the three-dimensional model of the object 105 included in the three-dimensional model generation target space 101 is generated by the shape from silhouette method described above. FIG. 8B illustrates an example of a generation result of the three-dimensional model. The shape estimation unit 204 can specify a voxel range to be excluded by each of the cameras 102 from the effective depth range 301 of the corresponding camera 102. For example, the silhouette image of the camera 102A is only used for generation of a three-dimensional model 720B that is within the effective depth range 301A in FIG. 8B. A three-dimensional model 720A and a three-dimensional model 720C are outside the effective depth range 301A even if they appear in the view angle, and therefore they are not used for generation of these models. A three-dimensional model 720 of the object is generated as the three-dimensional models 720A to 720C at positions corresponding to the actual objects 105A to 105C in the three-dimensional model generation target space 101. The shape estimation unit 204 outputs the generated three-dimensional model 720 of the object to the partial region specification unit 205.

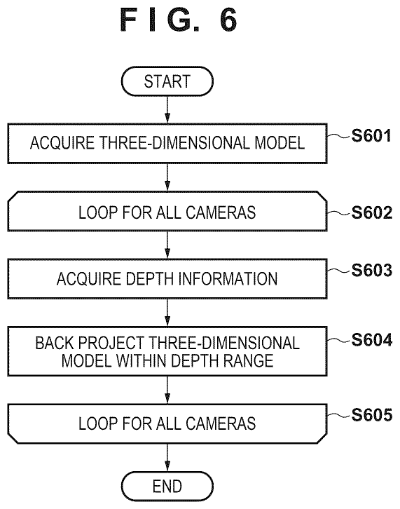

In S507, the partial region specification unit 205 specifies the object region (partial region) used for generation of the three-dimensional model among the objects appearing in each of the cameras 102 on the camera view angle. The processing content of S507 will be described with reference to the flowchart shown in FIG. 6.

In S601, the partial region specification unit 205 acquires a three-dimensional model. For example, the partial region specification unit 205 acquires a three-dimensional model by receiving the three-dimensional model 720 from the shape estimation unit 204.

In S602, the partial region specification unit 205 starts a loop of all the cameras 102. The example illustrated in FIG. 1 assumes a loop from the camera 102A to the camera 102P.

In S603, the partial region specification unit 205 acquires depth information. In the present step, the partial region specification unit 205 acquires the effective depth range 301 of each of the cameras 102 as depth information.

In S604, the partial region specification unit 205 performs back projection of the three-dimensional model within the effective depth range. Here, a method of back projecting the three-dimensional model included in the effective depth range 301A of the camera 102A of the three-dimensional model 720 will be described with reference to FIG. 8B. Since the three-dimensional model 720 included in the effective depth range 301A of the camera 102A is the three-dimensional model 720B corresponding to the object 105B, this three-dimensional model 720B is back projected onto the silhouette image 702 of the camera 102A. This can specify the partial region used for generation processing of the three-dimensional model in the silhouette image 702.

An example of a specification result of the partial region is illustrated in a partial region image 703 in FIG. 8C. In the partial region image 703, the object silhouette 710B corresponding to the object 105B in the silhouette image 702 is illustrated as a use area 730B that is a partial region used for generation of the three-dimensional model. On the other hand, the object silhouettes 710A and 710C corresponding to the objects 105A and 105C not included in the effective depth range 301 are illustrated as a non-use area 740A and a non-use area 740C indicated by hatched portions. The partial region specification unit 205 outputs a partial region image including these use area and non-use areas to the display control unit 206 as partial region information. In the partial region image 703, the object silhouette 710B may be displayed in any display manner as long as it is displayed distinguishably from the object silhouettes 710A and 710C.

In S605, in a case where the loop of all the cameras 102 has ended, the partial region specification unit 205 ends the processing. In a case where there is still the camera 102 that is remaining, the process returns to S602 to repeat the processing. In the example illustrated in FIG. 1, when the processing of S603 and S604 is completed for each camera from the camera 102A to the camera 102P, this loop ends.

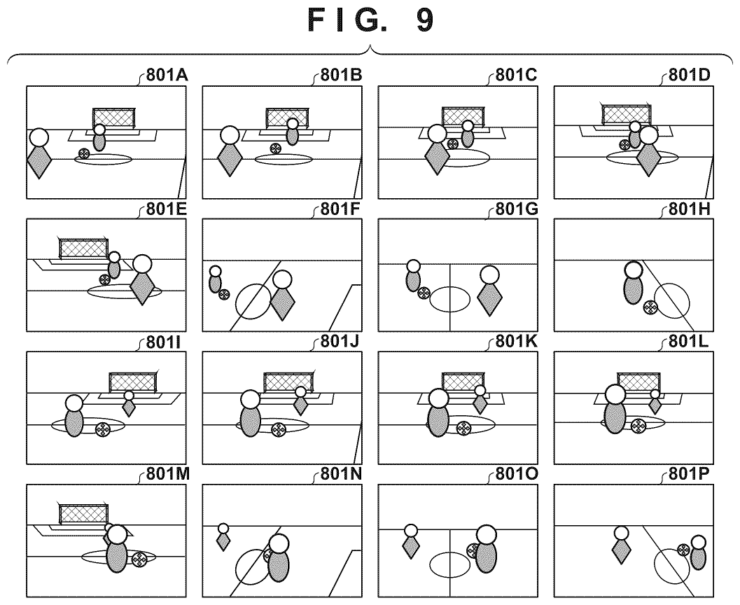

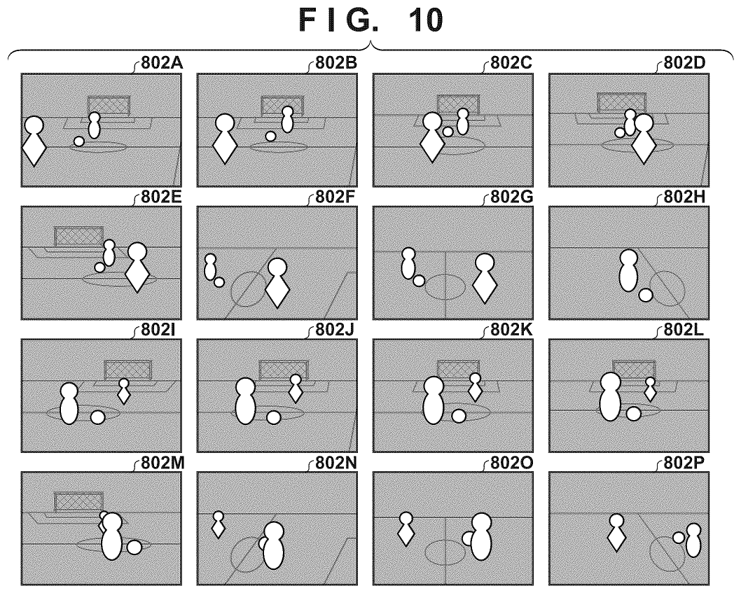

Next, the description returns to the flowchart in FIG. 5. In S508, the display control unit 206 displays a partial region (region used for generation of the three-dimensional model). The display control unit 206 displays a partial region image including the partial region that is the object region used for generation of the three-dimensional model in each of the cameras 102 specified in S507. The display control unit 206 can also display a captured image of each of the cameras 102 and a silhouette image. Display examples of the captured image, the silhouette image, and the partial region image are illustrated in FIGS. 9, 10, and 11, respectively.

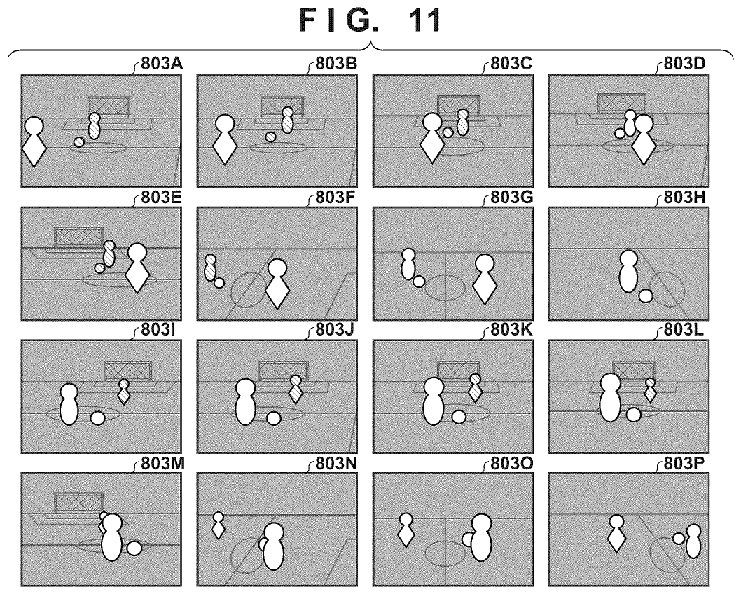

FIG. 9 illustrates a captured image 801A to a captured image 801P corresponding to the camera 102A to the camera 102P. In each image, the object included in the image capturing range of each of the cameras 102 is captured. FIG. 10 illustrates a silhouette image 802A to a silhouette image 802P corresponding to the camera 102A to the camera 102P. The silhouette image 802 includes an object silhouette corresponding to the object included in the captured image of each of the cameras 102. FIG. 11 illustrates a partial region image 803A to a partial region image 803P corresponding to the camera 102A to the camera 102P. They are partial region images in which, in the object silhouette corresponding to the object included in the captured image of each of the cameras 102, a use area used for generation of the three-dimensional model is indicated by a white filled portion, and a non-use area not used is indicated by a hatched portion.

In this manner, by displaying the use area and the non-use area with the silhouette image as a base for each of the cameras 102, it is possible to easily confirm, on the image, which object among the objects captured by the cameras 102 to have contributed to the generation of the three-dimensional model. Note that in the present embodiment, an example in which the partial region and the other regions are differentiated with the white filled portion and the hatched portion has been described, but a display method in which the partial region and the other regions are filled with different colors may be used. That is, any display manner may be used as long as the use area and the non-use area can be distinguishably displayed in different display manners. Note that it is not necessary to fill the entire region with a specific color, and for example, the color of an edge of the region may be changed between the use area and the non-use area. That is, the display color of the edge of the use area and the display color of the edge of the non-use area may be changed.

By this, for example, it is possible to perform, while confirming the partial region image, adjustment of a separation parameter of an object with low separation accuracy among objects included in the silhouette image of the object used for generation of the three-dimensional model and adjustment of the effective depth range for each camera.

As described above, in the present embodiment, the partial region indicating the object region contributing to generation of the three-dimensional model in the object region is specified based on the three-dimensional model and the depth information corresponding to each image capturing device. This can specify which object among the objects included in the captured images acquired by the plurality of image capturing devices to have contributed to generation of the three-dimensional model.

In the present embodiment, among the objects in the captured image, the object present in a predetermined distance range from the image capturing unit 201 and an object not present in a predetermined distance range are distinguishably displayed. More specifically, the partial region that is the object region used for generation of the three-dimensional model is superimposed on the silhouette image of the object. By this, it is possible to easily confirm which part (which object) in the silhouette image of the object included in the captured images acquired by the plurality of image capturing devices to have been used for generation of the three-dimensional model.

Therefore, the parameters for separating the object region can be easily adjusted. By avoiding unnecessary parameter adjustment for an object not used for generation of the three-dimensional model, it is possible to suppress a decrease in separation accuracy of the object captured within the in-focus range.

### VARIATION EXAMPLE

In the above embodiment, overlapping the silhouette image of the object and the partial region used for generation of the three-dimensional model, and changing the display colors of the partial region and the other regions have been described, but the display method is not limited to this.

For example, by calculating the distance between the camera and the three-dimensional model in FIG. 8B, it is also possible to superimpose a depth map in which the hue and shade of the color are changed depending on the depth on the silhouette image and the partial region of the object at the time of display. The depth map is map information indicating the distance from the image capturing unit 201 to the object. In a case where the depth map is superimposed, whether or not to be a partial region may be indicated by indicating a boundary color between a part used and a part not used for generation of the three-dimensional model, for example.

By this, it is possible to confirm at which position a certain object is present relative to the effective depth range, and therefore it is possible to easily adjust the effective depth range. The depth map used for this superimposition display may be not only obtained from the relative positional relationship between the camera and the three-dimensional model but also acquired from a depth sensor mounted on the camera.

According to the present disclosure, it is possible to confirm as to which object of the objects included in captured images acquired by a plurality of image capturing devices to be included in a predetermined range.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-133274, filed Aug. 8, 2024, which is hereby incorporated by reference herein in its entirety.

What is claimed is:

1. An image processing system, comprising:
one or more memories storing instructions; and
one or more processors executing the instructions to:
acquire an image based on image capturing by an image capturing device and depth information indicating a predetermined distance range from the image capturing device; and
display, in different display manners, a first object present in the predetermined distance range and a second object not present in the predetermined distance range among objects in the image.

2. The image processing system according to claim 1, wherein the depth information is set by a user.

3. The image processing system according to claim 1, wherein the depth information is determined by setting of the image capturing device.

4. The image processing system according to claim 1, wherein the depth information is information based on a focal length of the image capturing device.

5. The image processing system according to claim 1, wherein the first object and the second object are displayed in different colors.

6. The image processing system according to claim 1, wherein
the one or more processors further execute the instructions to further display a depth map indicating a distance from the image capturing device to an object.

7. The image processing system according to claim 1, wherein
the one or more processors further execute the instructions to specify the first object in the predetermined distance range.

8. The image processing system according to claim 7, wherein the first object is specified based on a three-dimensional model generated based on the image, the three-dimensional model being included in a range corresponding to the predetermined distance range in a virtual space.

9. The image processing system according to claim 1, wherein the first object is an object corresponding to a three-dimensional model generated based on the image, the three-dimensional model being included in a range corresponding to the predetermined distance range in a virtual space.

10. A control method, comprising:
acquiring an image based on image capturing by an image capturing device and depth information indicating a predetermined distance range from the image capturing device; and
displaying, in different display manners, a first object present in the predetermined distance range and a second object not present in the predetermined distance range among objects in the image.

11. A non-transitory computer-readable storage medium storing a program for causing a computer to execute a control method including:
acquiring an image based on image capturing by an image capturing device and depth information indicating a predetermined distance range from the image capturing device; and
displaying, in different display manners, a first object present in the predetermined distance range and a second object not present in the predetermined distance range among objects in the image.
